(19) United States
(12) Patent Application Publication
(10) Pub. No.: US 2026/0349892 A1
(43) Pub. Date: Nov. 5, 2026

(54) DATA COLLECTION SYSTEM, IN-VEHICLE DEVICE, DATA COLLECTION METHOD, AND PROGRAM

(71) Applicant: DENSO CORPORATION, Kariya-shi (JP)

(72) Inventors: Mamoru HOSOKAWA, Kariya-shi (JP); Kensho TAKI, Kariya-shi (JP); Shinichi KOIKE, Kariya-shi (JP)

(21) Appl. No.: 19/716,488

(22) Filed: Jun. 23, 2026

Related U.S. Application Data
(63) Continuation of application No. PCT/JP2024/045230, filed on Dec. 20, 2024.

(30) Foreign Application Priority Data
Dec. 28, 2023 (JP) 2023-223274

(51) Int. Cl. G06F 11/30; G06F 11/34; G06F 16/2455

(52) U.S. Cl. CPC G06F 11/3013; G06F 11/3476; G06F 16/24565

(57) ABSTRACT

A data collection system acquires a first determination data used for a first condition from a vehicle according to trigger information and determines whether or not the first condition is met by using the first determination data. The data collection system acquires, from the vehicle, a processing target data required for generating a second determination data used for a second condition and determines whether or not the second condition is met by using the second determination data being a processing result of the specific processing executed on the processing target data. Upon determining that the first condition is met and the second condition is met, the data collection system acquires one or more retrieval data items linked to the trigger condition.

### CROSS REFERENCE TO RELATED APPLICATION

This application is a continuation application of International Patent Application No. PCT/JP2024/045230 filed on Dec. 20, 2024, which designated the U.S. and claims the benefit of priority from Japanese Patent Application No. 2023-223274 filed on Dec. 28, 2023. The entire disclosures of all of the above applications are incorporated herein by reference.

### TECHNICAL FIELD

The present disclosure relates to a technology for collecting data from vehicles necessary for improving applications.

### BACKGROUND

There is a technology for distributing information indicating a collection condition and a collection target data from a server to multiple vehicles and collecting data representing a status at a time of establishing the collection condition from each vehicle.

### SUMMARY

According to an aspect of the present disclosure, a data collection system acquires a first determination data used for a first condition from a vehicle according to trigger information and determines whether or not the first condition is met by using the first determination data. The data collection system acquires, from the vehicle, a processing target data required for generating a second determination data used for a second condition and determines whether or not the second condition is met by using the second determination data being a processing result of the specific processing executed on the processing target data. Upon determining that the first condition is met and the second condition is met, the data collection system acquires one or more retrieval data items linked to the trigger condition.

### BRIEF DESCRIPTION OF DRAWINGS

FIG. 1 is a block diagram showing a configuration of a data collection system.

FIG. 2 is a block diagram showing a configuration of an in-vehicle device.

FIG. 3 is a block diagram showing a configuration of a management center.

FIG. 4 is a functional block diagram showing functions of the data collection system.

FIG. 5 is an explanatory diagram showing an example of a trigger condition contained in trigger information.

FIG. 6 is an explanatory diagram showing an example of a retrieval data item list contained in the trigger information.

FIG. 7 is an explanatory diagram showing a configuration of adjustment parameters.

FIG. 8 is a sequence diagram showing basic operations between an in-vehicle device and an ECU/retrofit-device group.

FIG. 9 is a sequence diagram showing operations between the management center and the in-vehicle device.

FIG. 10 is a flowchart of a dissatisfaction survey process.

FIG. 11 is a flowchart of a proxy process.

### DETAILED DESCRIPTION

There is a technology for distributing information indicating a collection condition and a collection target data from a server to multiple vehicles and collecting data representing a status at a time of establishing the collection condition from each vehicle.

For efficient improvement of an application program implementing a vehicle functionality, it is conceivable to collect annotated data such as data detected under a situation where the driver is feeling dissatisfied.

However, such an issue has been found that highly accurate detection of driver's dissatisfaction using information of a single vehicle operation, or the like alone acquired via an in-vehicle network is impossible.

The present disclosure provides a technology for accurately collecting annotated data.

According to a first aspect of the present disclosure, a data collection system is provided that comprises: a distributor, a trigger storage, a first acquirer, a first determiner, a second acquirer, an information processor, a second determiner, a third acquirer, and a collector. The distributor is configured to distribute, to one or more vehicles, trigger information in which a trigger condition and one or more retrieval data items to be acquired upon establishment of the trigger condition are linked to each other. The trigger condition indicates a condition that a determination data is to meet. The trigger condition is defined by a first condition and a second condition in combination. The second condition is a condition separate from the first condition. A result of specific processing on one or more data items acquired from the vehicle is used as the determination data for the second condition. The trigger storage in a target vehicle is configured to store the trigger information. The target vehicle is the vehicle to which the trigger information is distributed. The first acquirer is configured to acquire, from the target vehicle, a first determination data being the determination data that is used for the first condition according to the trigger information stored in the trigger storage. The first determiner is configured to determine whether or not the first condition is met, by using the first determination data acquired by the first acquirer. The second acquirer is configured to acquire, from the target vehicle, a processing target data required for generating a second determination data being the determination data that is used for the second condition. The information processor is configured to execute the specific processing using the processing target data acquired by the second acquirer. The second determiner is configured to determine whether or not the second condition is met, by using the second determination data which is a processing result of the information processor. The third acquirer is configured to, upon the first determiner determining that the first condition is met and the second determiner determining that the second condition is met, acquire the one or more retrieval data items linked to the trigger condition in the trigger information, from the target vehicle. The collector is configured to collect the one or more retrieval data items acquired at the third acquirer from a plurality of the vehicles.

According to this configuration, by including the second condition in the trigger condition and utilizing the second determination data generated by the specific processing, it is possible to improve detection accuracy of a situation represented by the second determination data, e.g., user dissatisfaction, emotion, etc. In other words, it is possible to accurately collect annotated data detected under the situation indicated by the second determination data.

According to a second aspect of the present disclosure, an in-vehicle device is provided that comprises: a trigger storage configured to store trigger information in which a trigger condition and one or more retrieval data items to be acquired upon establishment of the trigger condition are linked to each other, wherein: the trigger condition indicates a condition that a determination data is to meet; the trigger condition is defined by a first condition and a second condition in combination; the second condition is a condition separate from the first condition; and a result of specific processing on one or more data items acquired from a vehicle is used as the determination data for the second condition; a first acquirer configured to acquire, from the vehicle, a first determination data being the determination data that is used for the first condition according to the trigger information stored in the trigger storage; a first determiner configured to determine whether or not the first condition is met, by using the first determination data acquired by the first acquirer; a second acquirer configured to acquire, from the vehicle, a processing target data required for generating a second determination data being the determination data that is used for the second condition; a result acquirer configured to transmit the processing target data acquired by the second acquirer to an information processor device inside or outside the vehicle, and to acquire a processing result of the specific processing from the information processor device; a second determiner configured to determine whether or not the second condition is met, by using the processing result of the specific processing acquired by the result acquirer as the second determination data; a third acquirer configured to, upon the first determiner determining that the first condition is met and the second determiner determining that the second condition is met, acquire the one or more retrieval data items linked to the trigger condition in the trigger information, from the vehicle; and a transmitter configured to transmit the one or more retrieval data items acquired by the third acquirer to an external device.

According to this configuration, by using the in-vehicle device of the data collection system, it is possible to provide the same effect as the data collection system.

According to a third aspect of the present disclosure, a data collection method is provided that comprises: using trigger information in which a trigger condition and one or more retrieval data items to be acquired upon establishment of the trigger condition are linked to each other, wherein: the trigger condition indicates a condition that a determination data is to meet; the trigger condition is defined by a first condition and a second condition in combination; the second condition is a condition separate from the first condition; and a result of specific processing on one or more data items acquired from a vehicle is used as the determination data for the second condition; acquiring, from the vehicle, a first determination data being the determination data that is used for the first condition according to the trigger information; determining whether or not the first condition is met, by using the first determination data; acquiring, from the vehicle, a processing target data required for generating a second determination data being the determination data that is used for the second condition; transmitting the processing target data to an information processor device inside or outside the vehicle, and acquiring a processing result of the specific processing from the information processor device; determining whether or not the second condition is met, by using the processing result of the specific processing as the second determination data; upon determining that the first condition is met and the second condition is met, acquiring the one or more retrieval data items linked to the trigger condition in the trigger information, from the vehicle; and transmitting the one or more retrieval data items to an external device.

By using this method, it is possible to provide the same effect as the data collection system.

According to a fourth aspect of the present disclosure, a program is provided that causes a computer to use trigger information in which a trigger condition and one or more retrieval data items to be acquired upon establishment of the trigger condition are linked to each other, wherein: the trigger condition indicates a condition that a determination data is to meet; the trigger condition is defined by a first condition and a second condition in combination; the second condition is a condition separate from the first condition; and a result of specific processing on one or more data items acquired from a vehicle is used as the determination data for the second condition. The program causes the computer to function as: a first acquirer configured to acquire, from the vehicle, a first determination data being the determination data that is used for the first condition according to the trigger information; a first determiner configured to determine whether or not the first condition is met, by using the first determination data acquired by the first acquirer; a second acquirer configured to acquire, from the vehicle, a processing target data required for generating a second determination data being the determination data that is used for the second condition; a result acquirer configured to transmit the processing target data acquired by the second acquirer to an information processor device inside or outside the vehicle, and to acquire a processing result of the specific processing from the information processor device; a second determiner configured to determine whether or not the second condition is met, by using the processing result of the specific processing acquired by the result acquirer as the second determination data; a third acquirer configured to, upon the first determiner determining that the first condition is met and the second determiner determining that the second condition is met, acquire the one or more retrieval data items linked to the trigger condition in the trigger information, from the vehicle; and a transmitter configured to transmit the one or more retrieval data items acquired by the third acquirer to an external device.

By executing this program, it is possible to provide the same effect as the data collection system.

Embodiments of the present disclosure will be described with reference to the drawings.

### 1. Overall Configuration

A data collection system 1 of the present embodiment collects dissatisfaction survey data. The dissatisfaction survey data refers to annotated data usable for improvement of an application program implementing a vehicle functionality, such as data representing situations where drivers are feeling dissatisfied with the vehicle functionality.

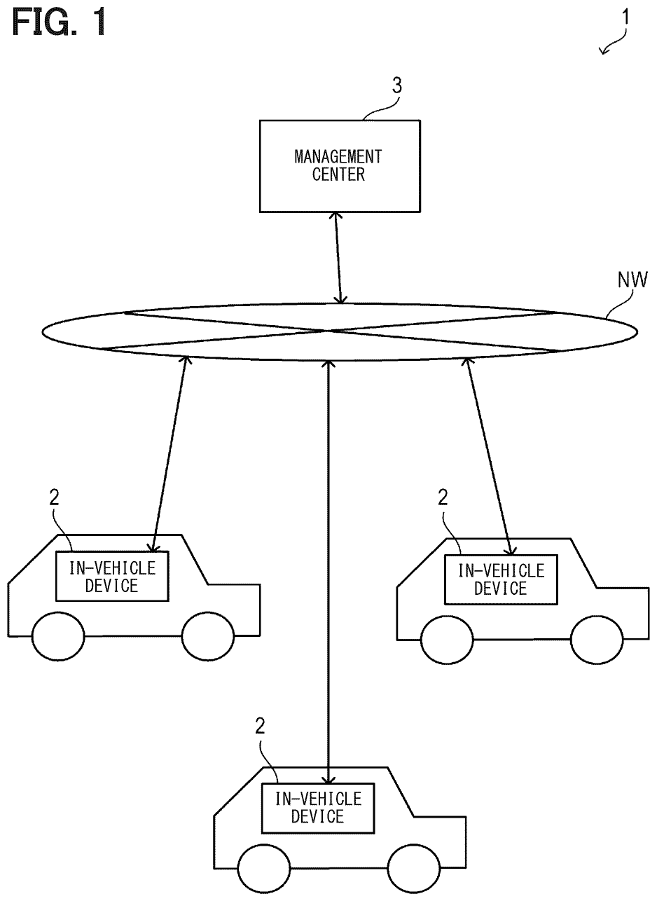

As shown in FIG. 1, the data collection system 1 includes multiple in-vehicle devices 2 and a management center 3.

The in-vehicle device 2 is mounted on the vehicle and has a function of performing data communication with the management center 3 via a wide-area wireless communication network NW.

The management center 3 has a function of performing data communication with the in-vehicle device 2 via the wide-area wireless communication network NW.

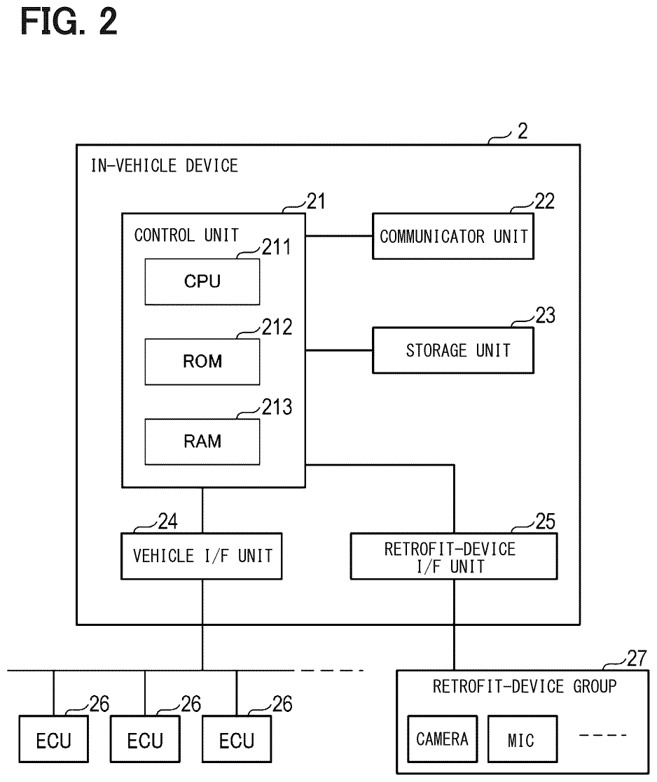

As shown in FIG. 2, the in-vehicle device 2 includes a control unit 21, a communication unit 22, a storage unit 23, a vehicle interface (hereinafter referred to as the vehicle I/F) unit 24, and a retrofit-device I/F unit 25.

The control unit 21 is an electronic control unit including, as its main component, a microcomputer including a CPU 211, a ROM 212, a RAM 213, and the like. Various functions of the microcomputer are implemented by the CPU 211 executing programs stored in a non-transitory tangible storage medium. In this example, the ROM 212 corresponds to the non-transitory tangible storage medium storing the programs. Note that part or all of the functions executed by the CPU 211 may be implemented by configuring hardware with one or more ICs. The number of microcomputers in the control unit 21 may be one or more.

The communication unit 22 performs data communication with the management center 3 via the wide-area wireless communication network NW.

The storage unit 23 is a storage device for storing various data.

For data communication, the vehicle I/F unit 24 is connected to multiple ECUs 26 via a CAN bus installed in the vehicle. CAN is an abbreviation for Controller Area Network. The vehicle I/F unit 24 transmits and receives data according to the CAN communication protocol.

For data communication, the retrofit-device I/F unit 25 is connected to a retrofit—device group 27, which is retrofitted to the vehicle. The retrofit-devices may include a camera, a microphone, a speaker, a display, an accelerometer, and a gyroscope.

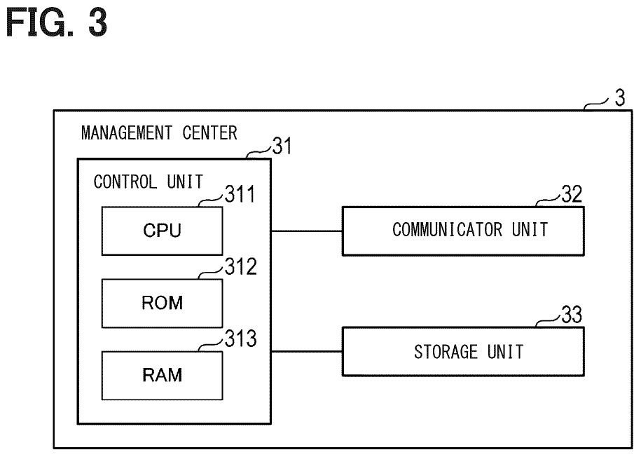

The management center 3 includes a control unit 31, a communication unit 32, and a storage unit 33, as shown in FIG. 3.

The controller 31 is an electronic control unit including, as its main component, a microcomputer including a CPU 311, a ROM 312, a RAM 313, and the like. Various functions of the microcomputer are implemented by the CPU 311 executing programs stored in a non-transitory tangible storage medium. In this example, the ROM 312 corresponds to the non-transitory tangible storage medium storing the programs. Note that part or all of the functions executed by the CPU 311 may be implemented by configuring hardware with one or more ICs. The number of microcomputers in the control unit 31 may be one or more.

The communication unit 32 performs data communication with multiple in-vehicle devices 2 via the wide-area wireless communication network NW.

The storage unit 33 is a storage device for storing various data.

### 2. Functional Configuration

Functional configuration of the data collection system 1 will be described below.

### 2-1. Management Center

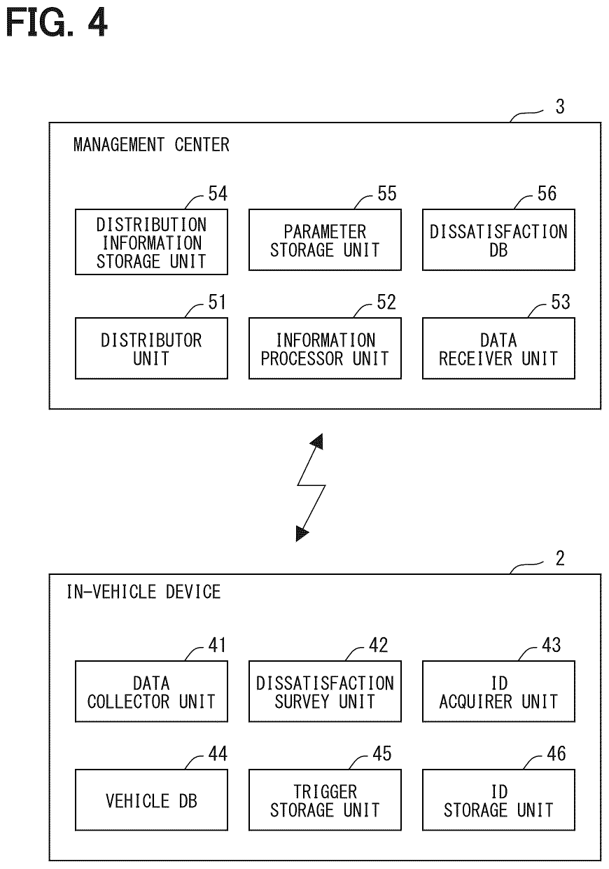

As shown in FIG. 4, the management center 3 includes a distributor unit 51, an information processor unit 52, and a data receiver unit 53 as functional blocks implemented by the CPU 311 executing the program stored in the ROM 312. The storage unit 33 of the management center 3 includes a distribution information storage unit 54, a parameter storage unit 55, and a dissatisfaction database (hereinafter referred to as dissatisfaction DB) 56.

The distribution information storage unit 54 stores retrieval information to be distributed to the vehicles. The retrieval information includes one or more trigger information records. The trigger information record is information in which a trigger condition and a retrieval data item list are linked to each other. Each trigger information record is identified by its trigger ID.

The trigger condition is defined by one or more individual conditions in combination. The individual condition indicates a condition that a single piece of determination data is to meet. Individual conditions are categorized into a first-type condition and a second-type condition based on differences in types of determination data. The first-type condition uses respective values of various data acquired at the vehicle as the determination data. As the determination data, the first-type condition may use a result of low-load processing on one or more data items (e.g., a small amount of data) acquired at the vehicle, wherein the low-load processing is performed in the vehicle. As the determination data, the second-type condition uses a result of predetermined specific processing on various data acquired at the vehicle. The specific processing may include, for example, speech recognition processing, image recognition processing, statistical processing, etc. The speech recognition processing recognizes, for example, words uttered by the driver. The image recognition processing recognizes, for example, a driver's status (e.g., facial expression, behavior) The statistical processing may include an operation of removing outliers from large datasets, etc. The specific processing may include a computationally intensive operation executed using a large amount of data.

The retrieval data item list indicates one or more data items to be acquired as dissatisfaction survey data upon establishment of the trigger condition.

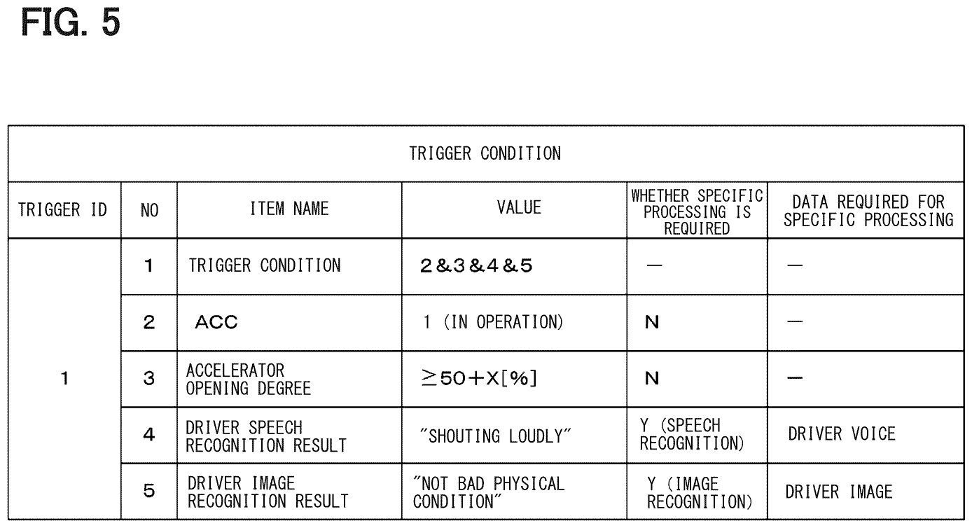

FIG. 5 shows an example of how the trigger condition is defined.

The trigger condition is defined so that the trigger condition is linked to the trigger ID. The trigger condition includes individual conditions listed as shown in No. 2 to No. 5 in FIG. 5, along with a manner of combining these individual conditions as shown in No. 1 in FIG. 5. In this case, all the individual conditions are combined using logical AND. Alternatively, logical OR, negation, etc., may be included.

The individual condition specifies the determination data to be used, values that the determination data is to meet, whether or not the specific processing is required, and data required for the specific processing.

Depending on whether or not the specific processing is required, it is determined whether it is the first-type condition or the second-type condition. Specifically, if the specific processing is not required (i.e., N), it is the first-type condition; if the specific processing is required (i.e., Y), it is the second-type condition. When the specific processing is required, it may be specified what type of the specific processing is to be executed.

A first-type determination data, which is the determination data used for the first-type condition, may include, for example, an ACC operation status and an accelerator pedal position. The condition may be met when the ACC operation status is “in operation” or “in stopped state.” The condition may be met when the accelerator pedal position is “50% or more”, for example. Note that X is a value that is adjustable by the adjustment parameter stored in the parameter storage unit 55.

A second-type determination data, which is the determination data used for the second-type condition, may include, for example, a driver speech recognition result, a driver image recognition result, etc. The specific processing is required to acquire the driver speech recognition result, and the driver speech is designated as the data required for the specific processing. The condition may be met when the driver speech recognition result is “shouting loudly,” for example. The specific processing is required to acquire the driver image recognition result, and the driver image is designated as the data required for this specific processing. The condition may be met when the driver image recognition result is “not bad physical condition”. Not only the data type but also an acquisition duration, data amount, etc., may be designated as the data required for the specific processing.

Note that the trigger condition does not necessarily include the first-type condition and the second-type condition in combination. For example, the trigger condition may be the first-type condition alone. The trigger condition may include at least one condition for detecting that the driver is expressing dissatisfaction.

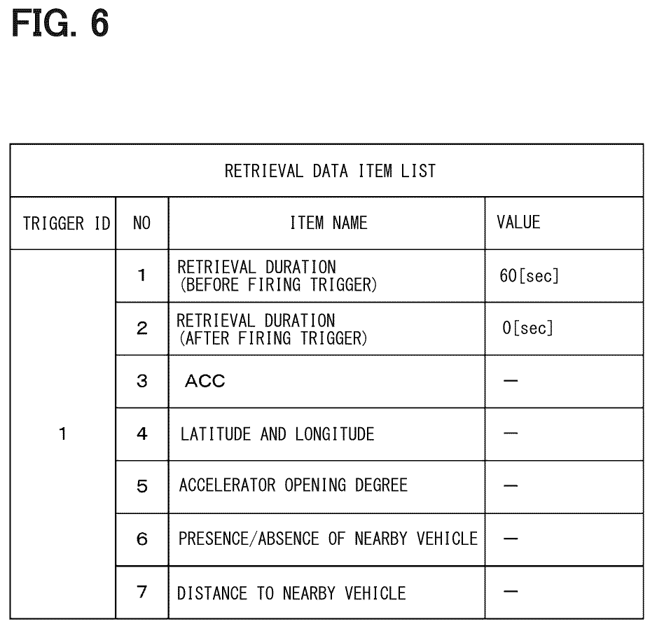

FIG. 6 shows an example of how the retrieval data item list is defined.

The retrieval data item list is defined so that the retrieval data item list is linked to the trigger ID. In other words, it is linked to the trigger condition via the trigger ID. Furthermore, a single trigger information record is formed with the trigger condition and the retrieval data item list linked to each other via the trigger ID. The retrieval data item list lists up the data items to be acquired, as shown in No. 3 to No. 7 in FIG. 6. Additionally, the retrieval data item list may indicate the data retrieval duration, as shown in No. 1 and No. 2 in FIG. 6. The retrieval duration may be specified as two separate durations: a duration before firing the trigger (firing the trigger is also called establishing the condition) and a duration after firing the trigger.

The retrieval data items may include an operational status of a control (e.g., ACC), the driver's driving operation status (e.g., accelerator pedal position), the vehicle's position (e.g., latitude and longitude), and an environment around the vehicle (e.g., presence/absence of nearby vehicles, distance to nearby vehicles).

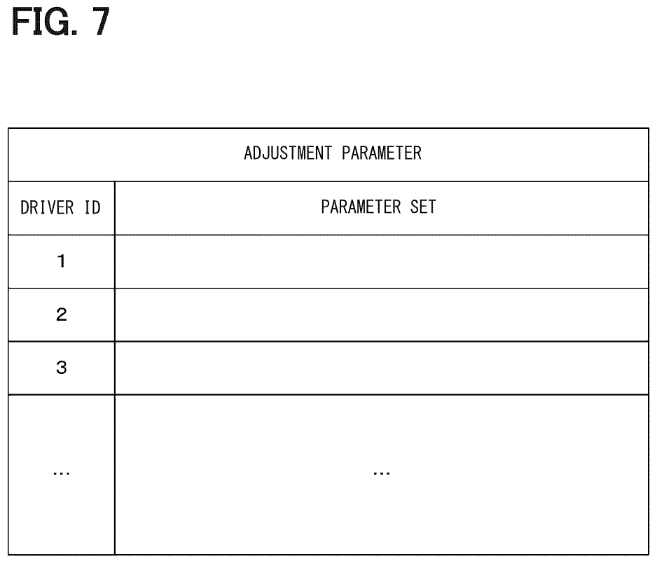

The description returns to FIG. 4. The parameter storage unit 55 stores an adjustment parameter. The adjustment parameter is one or more parameters used at execution of the specific processing. As shown in FIG. 7, the adjustment parameter is set for each driver ID. The adjustment parameter may be used to absorb individual differences and improve accuracy in determination made in the specific processing. The adjustment parameter may be used to change models or thresholds used for the specific processing depending on drivers'tendencies (e.g., loud voice, prone to irritability, etc.). The adjustment parameter may be set based on self-reporting from the driver or may be set via collection of driving data and execution of learning process for the adjustment parameter.

The dissatisfaction DB 56 stores the dissatisfaction survey data that the vehicles, to which the retrieval information has been distributed, transmit based on the retrieval information. The dissatisfaction survey data is a data indicated in the retrieval data item list.

When a given distribution condition is met, the distributor unit 51 distributes the retrieval information stored in the distribution information storage unit 54 to each target vehicle.

When the information processor unit 52 receives a request to execute the specific processing from the in-vehicle device 2 along with a processing target data, the information processor unit 52 executes the specific process and transmits a processing result to the in-vehicle device 2 being the request source. In execution of the specific processing, the adjustment parameter stored in the parameter storage unit 55 is used. Details of processing executed by the information processor unit 52 will be described later.

When the data receiver unit 53 receives the dissatisfaction survey data from the vehicle to which the retrieval information has been distributed, the data receiver unit 53 stores the received dissatisfaction survey data in the dissatisfaction DB 56 while classifying it by the driver ID and the trigger ID.

### 2-2. In-Vehicle Device

As shown in FIG. 4, the in-vehicle device 2 includes a data collector unit 41, a dissatisfaction survey unit 42, and an ID acquirer unit 43 as functional blocks implemented by the CPU 211 executing the program stored in the RMO 212. The storage unit 23 of the in-vehicle device 2 includes a vehicle database (hereinafter referred to as the vehicle DB) 44, a trigger storage unit 45, and an ID storage unit 46.

The vehicle DB 44 stores data collected by the data collector unit 41. The vehicle DB 44 stores data for a given period or longer, configured to ensure that no data potentially subject to the specific processing is missing and that whole of the retrieval duration indicated in the retrieval data item list is covered.

The trigger storage unit 45 stores the retrieval information distributed from the management center 3. Addition or update of the retrieval information may be as appropriate, in units of trigger information record identified by the trigger ID, following a command from the management center 3.

The ID storage unit 46 stores the driver ID acquired by the ID acquirer unit 43. The driver ID is information that identifies the driver who is currently in the vehicle equipped with the in-vehicle device 2.

The data collector unit 41 collects various data provided by the ECU 26 and the retrofit-device group 27 in a chronological order via the vehicle I/F unit 24 and the retrofit-device I/F unit 25. The data collected via the vehicle I/F unit 24 may include behavior data representing vehicle behavior, operation data representing driver operation, status data representing the status of onboard equipment, and diagnostic data generated by each ECU 26. Hereinafter, the behavior data, the operation data, the status data, and the diagnostics data are collectively referred to as vehicle data.

The data collected via the retrofit-device I/F unit 25 may include driver voice data, image data capturing the driver's facial expression and his or her upper body movement, and biometric data representing the driver's body temperature, heart rate, and other such information. Hereinafter, the voice data, the image data, the biometric data, and other data related to the driver are collectively referred to as driver data.

Furthermore, the data collector unit 41 may acquire the driver data from devices originally installed in the vehicle via the vehicle interface unit 24. Additionally, the data collector unit 41 may acquire the vehicle data from the retrofit-device group 27, which is retrofitted to the vehicle, via the retrofit-device I/F unit 25.

The dissatisfaction survey unit 42 may be implemented, for example, by executing an application program distributed from the management center 3. The dissatisfaction survey unit 42 determines whether or not the trigger condition is established based on a retrieval information table stored in the trigger storage unit 45. The dissatisfaction survey unit 42 transmits the data indicated in the retrieval data item list linked to the established trigger condition to the management center 3 as the dissatisfaction survey data. Details of processes in the dissatisfaction survey unit 42 will be described later.

At start-up of the in-vehicle device 2, the ID acquirer unit 43 recognizes the driver who is currently in the vehicle equipped with the in-vehicle device 2, acquires the driver ID of the recognized driver, and stores it in the ID storage unit 46.

### 3. Operation

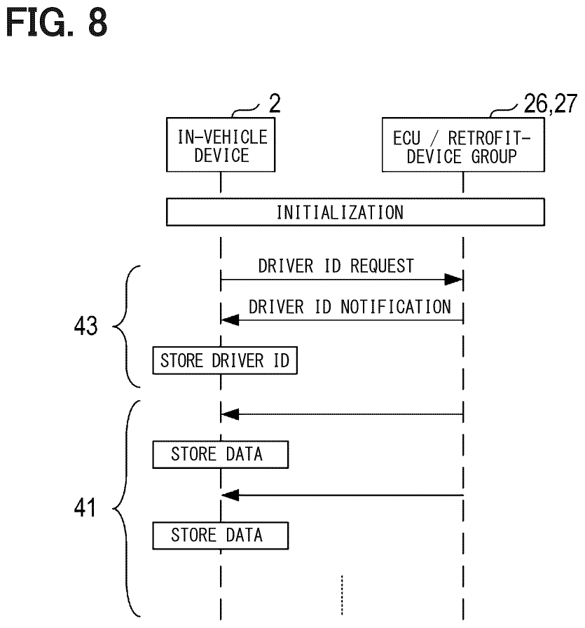

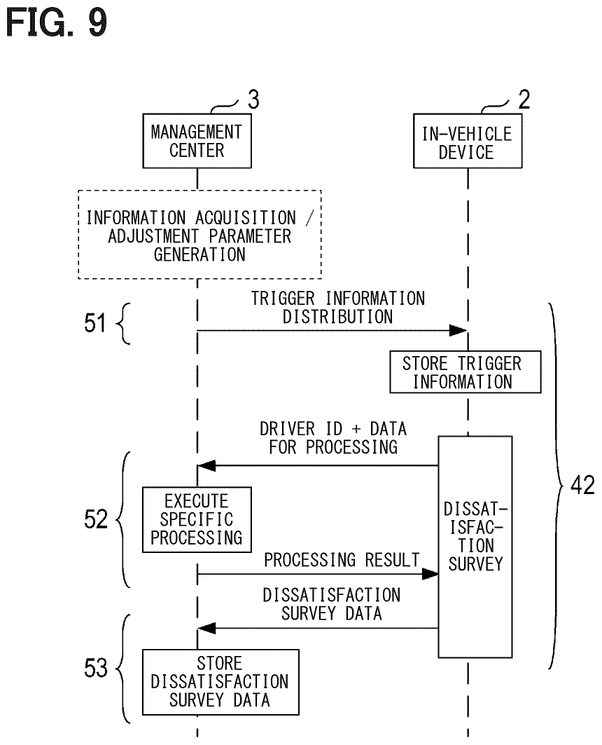

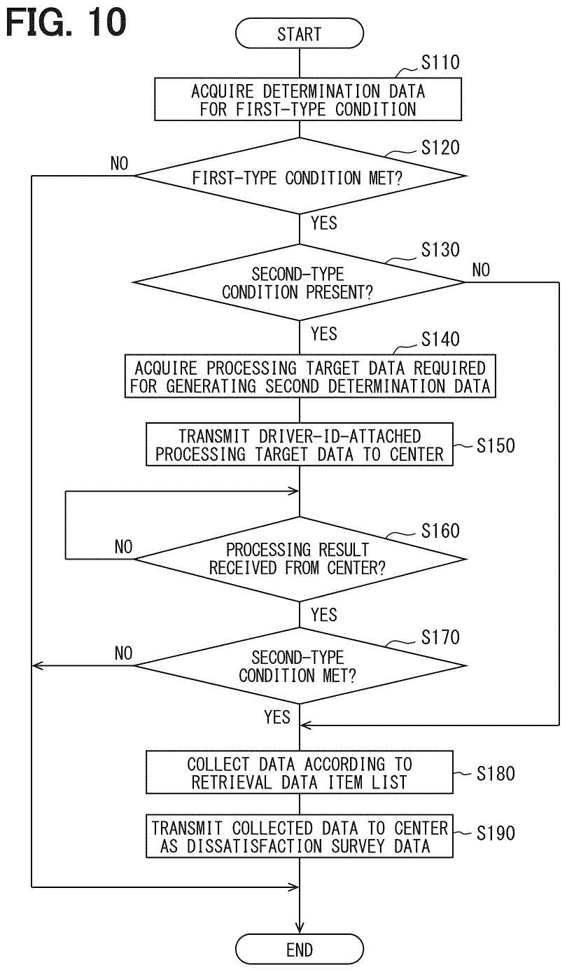

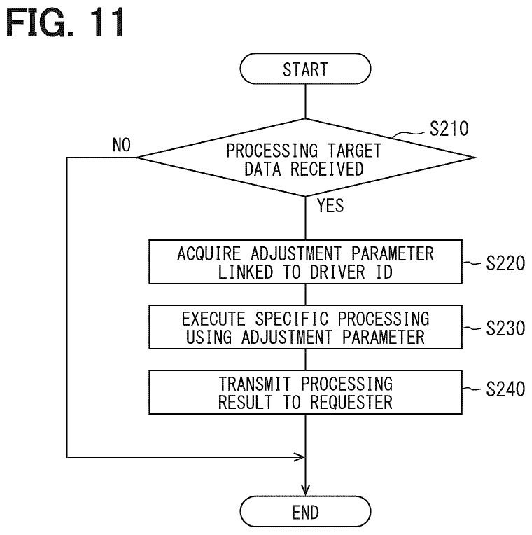

The operation of the data collection system 1 will be described using the sequence diagrams shown in FIGS. 8 and 9, and the flowcharts shown in FIGS. 10 and 11.

As shown in FIG. 8, when the vehicle power is turned on, the in-vehicle device 2 and he ECU 26 start up, and the initialization process is executed. In response to be able to communicate with the ECU 26 via the in-vehicle I/F unit 24 and with the retrofit-device group 27 via the retrofit-device I/F unit 25 by initialization process, the control unit 21 of the in-vehicle device 2 executes processes as the ID acquirer unit 43. Specifically, the control unit 21 acquires the driver ID and stores the acquired driver ID in the ID storage unit 46. The driver ID may be acquired, for example, through an application programming interface (API) that provides various vehicle functions. Specifically, for example, the driver may be identified based on an image of the driver.

Subsequently, the control unit 21 executes a process as the data collector unit 41. Specifically, the control unit 21 monitors data flowing in the CAN bus, extracts the vehicle data that needs to be collected, and stores it in the vehicle database 44. Additionally, the control unit 21 may acquire necessary vehicle data and driver data at any desired timing by utilizing the API.

As shown in FIG. 9, the control unit 31 of the management center 3 generates the trigger information and the adjustment parameter as appropriate and updates the contents of the distribution information storage unit 54 and the parameter storage unit 55. Furthermore, the contents of the distribution information storage unit 54 and the parameter storage unit 55 may be updated based on the trigger information and the adjustment parameter generated at an outside of the management center 3.

The control unit 31 executes a process as the distributor unit 51 as appropriate. Specifically, following a command from an outside, the control unit 31 distributes the retrieval information stored in the distribution information storage unit 54 to the in-vehicle device 2 of a designated vehicle. The retrieval information may be distributed to all vehicles.

The control unit 21 of the in-vehicle device 2 receives the retrieval information distributed from the management center 3 and executes a process as the dissatisfaction survey unit 42. Specifically, the control unit 21 stores the distributed retrieval information in the trigger storage unit 45 and repeatedly executes the dissatisfaction survey process to collect the dissatisfaction survey data based on the retrieval information stored in the trigger storage unit 45.

Now, the dissatisfaction survey process executed by the control unit 21 will be described using the flowchart in FIG. 10. The dissatisfaction survey process is executed for each trigger information record identified by the trigger ID listed in the retrieval information.

In S110, the control unit 21 acquires the first-type determination data used for the first-type condition contained in the trigger condition of the retrieval information of interest. The first-type determination data may be acquired from the vehicle DB 44 or may be acquired directly from the ECU 26 or the retrofit-device group 27 using the API.

In S120, the control unit 21 determines whether or not the first-type condition is met. If the first-type condition is met, the process proceeds to S130. If the first-type condition is not met, the process is ended.

In S130, the control unit 21 determines whether or not the trigger condition includes the second-type condition. If the second-type condition is included, the process proceeds to S140. If the second-type condition is not included, the process proceeds to S180.

In S140, the control unit 21 acquires the processing target data required for generating the second-type determination data used for the second-type condition. The target data may be acquired from the vehicle database DB 44, or directly from the ECU 26 or the retrofit-device group 27 using the API. The processing target data may include, for example, the driver data on the driver who is in the vehicle equipped with the in-vehicle device 2, and the vehicle data required for a complex vehicle status and a complex driving operation to be specified.

In S150, the control unit 21 transmits the acquired processing target data to the management center 3 attached with the driver ID stored in the ID storage unit 46, thereby requesting the management center 3 to execute the specific processing using the processing target data.

In S160, the control unit 21 determines whether or not a processing result has been received from the management center 3. If the processing result has not received, the control unit 21 waits by repeating the same step. If the processing result has been received, it proceeds to S170.

In S170, by using the received processing result as the second-type determination data, the control unit 21 determines whether or not the second-type condition is met. If the second-type condition is met, the process proceeds to S180. If the second-type condition is not met, the processing is ended.

In S180, the control unit 21 refers to the retrieval information stored in the trigger storage unit 45 and collects the data indicated in the retrieval data item list according to the retrieval data item list linked to the trigger condition subject to the determination. The data indicated in the retrieval data item list may be acquired from the vehicle DB 44 or may be acquired directly from the ECU 26 or the retrofit-device group 27 using the API.

In S190, the control unit 21 transmits the data collected in S180 to the management center 3 as the dissatisfaction survey data and ends the process.

The description returns to FIG. 9. Upon receipt of the processing target data from the in-vehicle device 2, the control unit 31 of the management center 3 executes a process as the information processor unit 52 (hereinafter referred to as proxy process).

The proxy process executed by the control unit 31 of the management center 3 will be described using the flowchart in FIG. 11. The control unit 31 repeatedly executes the proxy process.

In step S210, the control unit 31 determines whether or not the control unit 31 has received the processing target data from the in-vehicle device 2. If the processing target data has been received, the process proceeds to step S220. If the processing target data has not been received, the process is ended.

In S220, the control unit 31 acquires a survey parameter linked to the driver ID attached to the processing target data from the parameter storage unit 55.

In S230, the control unit 31 executes the specific processing on the processing target data via applying the adjustment parameter.

In S240, the control unit 31 transmits the processing result of the specific processing to the in-vehicle device 2 being a source of the processing target data and ends the process.

The description returns to FIG. 9. When the control unit 31 of the management center 3 receives the dissatisfaction survey data from the in-vehicle device 2, the control unit 31 executes a process as the data receiver unit 53. Specifically, the control unit 31 classifies the received dissatisfaction survey data using the driver ID and the trigger ID attached to the dissatisfaction survey data and stores it in the dissatisfaction DB 56 for each classification.

### 4. Examples of Use of Trigger Condition

For example, the trigger condition shown in FIG. 5 is used to detect the driver status “exciting” or “anger” based on a rough accelerator operation, as well as the speech recognition result and the speech recognition result. Specifically, this trigger condition is established when an occurrence of a rough accelerator operation (i.e., accelerator opening ≥50+X%) is confirmed during the ACC, and the driver “shouting loudly” is confirmed by the speech recognition result and the driver “not bad physical condition” is confirmed by the image recognition result. When this trigger condition is established, the driver is considered to have dissatisfaction with the current ACC control, the data representing this situation from one minute prior to the establishment of the trigger condition is acquired and uploaded to the management center 3 as the dissatisfaction survey data.

Additionally, when an application program under test is executed in shadow mode alongside an application program in active operation within a vehicle, a difference between the active application and the application under test may be used as one piece of the determination data for the individual condition. The shadow mode application is executed without active influence on the equipment, based on inputs equivalent to those to the application program in active operation, so that the difference with the application program in active operation is detected.

For example, where a lane tracing assist (hereinafter referred to as LTA) function is used in the traveling, if the user cancels the LTA by performing a steering operation, a configured trigger condition may be a condition for determining whether or not the driver dissatisfaction is represented by that cancellation.

In this case, the individual condition in the trigger condition includes an ON state of the LTA and detecting the driver's steering operation (i.e., LTA canceling). The individual conditions may further include a highway as the road type at the traveling location. By including such individual conditions, it is possible to determine that the LTA cancellation was not due to entering an LTA-unpermitted road, improving the accuracy in detecting whether or not it is the driver dissatisfaction. Furthermore, the individual conditions may include the LTA logic in active operation differing from the LTA logic in the shadow mode. In this case, it is possible to efficiently collect data representing the driver's response to the application to be improved.

### 5. Correspondence of Terms

In the present embodiment, S110 corresponds to a first acquirer of the present disclosure, S120 corresponds to a first determiner of the present disclosure, S140 corresponds to a second acquirer of the present disclosure, and S150 to S160 correspond to a result acquirer of the present disclosure. In the present embodiment, S170 corresponds to a second determiner of the present disclosure, S180 corresponds to a third acquirer of the present disclosure, and S190 corresponds to a transmitter of the present disclosure. In the present embodiment, the data receiver unit 53 corresponds to a collector of the present disclosure, and the management center 3 corresponds to an external device of the present disclosure. In the present embodiment, the first-type condition corresponds to a first condition of the present disclosure, the second-type condition corresponds to a second-type condition of the present disclosure, the first-type determination data corresponds to a first determination data of the present disclosure, and the second-type determination data corresponds to a second determination data of the present disclosure.

### 6. Effects

The present embodiment described in detail so fart can provide the following effects.

(6a) In the data collection system 1, the trigger condition is configured using not only the vehicle data but also such information as driver's emotions estimated from the image data, the voice data, etc. Therefore, various data reflecting driver dissatisfaction with different application programs operating on the vehicle can be efficiently extracted.

(6b) In the data collection system 1, when the trigger condition includes the second-type condition, the in-vehicle device 2 acquires the second-type determination data by having the management center 3 perform the specific processing with a high processing load on its behalf. Therefore, in the in-vehicle device 2, the determination as to a complex trigger condition, which is required for detecting the driver dissatisfaction, can be made with minimal processing load. In other words, even vehicles with low processing power can accurately detect the driver dissatisfaction.

(6c) In the data collection system 1, the in-vehicle device 2 performs the determination as to the second-type condition requiring the specific processing only when all conditions other than the second-type condition (i.e., the first-type condition) are met. Therefore, the transmission of the target processing data when requesting the management center 3 for the specific processing can be minimized, reducing the communication volume between the in-vehicle device 2 and the management center 3.

(6d) In the data collection system 1 the adjustment parameters linked to the driver ID is applied to execution of the specific processing. Therefore, in detecting driver dissatisfaction, it is possible to reduce variations in detection accuracy caused by individual differences among drivers.

### 7. Other Embodiments

Although embodiments of the present disclosure have been described above, the present disclosure is not limited to the above embodiments, and various modifications can be made.

(7a) In the above embodiment, functions of distributing the retrieval information table, executing the specific processing, and accumulating the dissatisfaction survey data are provided in a single management center 3. Alternatively, respective functions may be provided in separate external devices such as separate servers.

(7b) In the above embodiment, the in-vehicle device 2 causes the information processor unit 52 of the management center 3 to execute the specific processing. However, if the vehicle includes an information processing device with high processing performance (e.g., an ECU dedicated to recognition), the information processing device may execute the specific processing. In this case, the communication volume between the in-vehicle device 2 and the management center 3 can be further reduced. Alternatively, the specific processing of different types may be executed by different information processing devices.

(7c) In the above embodiment, the specific processing personalized for each driver is executed using the adjustment parameter based on the driver ID. Alternatively, the specific processing common to all drivers may be executed without using the adjustment parameter.

(7d) Multiple functions of one element in the above embodiment may be implemented by multiple elements, or a function of one element may be implemented by multiple elements. Multiple functions of multiple elements may be implemented by one element, or one function implemented by multiple elements may be implemented by one element. In the above embodiments, part of the configuration may be omitted. At least part of the configuration of the above embodiment may be added to or substituted for the configuration of another embodiment.

(7e) In addition to the in-vehicle device 2, management center 3, and the data collection system 1, the present disclosure may encompasses various forms, such as program causing computers to function as the in-vehicle device and the management center, a non-transitory tangible storage medium such as a semiconductor memory storing the program, and a dissatisfaction survey data collection method.

### 8. Technical Ideas Disclosed in the Present Disclosure

(Item 1). A data collection system comprises:
a distributor (51) configured to distribute, to one or more vehicles, trigger information in which a trigger condition and one or more retrieval data items to be acquired upon establishment of the trigger condition are linked to each other, wherein: the trigger condition indicates a condition that a determination data is to meet; the trigger condition is defined by a first condition and a second condition in combination; the second condition is a condition separate from the first condition; and a result of specific processing on one or more data items acquired from the vehicle is used as the determination data for the second condition;
a trigger storage (45) in a target vehicle configured to store the trigger information, wherein the target vehicle is the vehicle to which the trigger information is distributed;
a first acquirer (21: S110) configured to acquire, from the target vehicle, a first determination data being the determination data that is used for the first condition according to the trigger information stored in the trigger storage;
a first determiner (21: S120) configured to determine whether or not the first condition is met, by using the first determination data acquired by the first acquirer;
a second acquirer (21: S140) configured to acquire, from the target vehicle, a processing target data required for generating a second determination data being the determination data that is used for the second condition;
an information processor (52) configured to execute the specific processing using the processing target data acquired by the second acquirer;
a second determiner (21: S170) configured to determine whether or not the second condition is met, by using the second determination data which is a processing result of the information processor;
a third acquirer (21: S180) configured to, upon the first determiner determining that the first condition is met and the second determiner determining that the second condition is met, acquire the one or more retrieval data items linked to the trigger condition in the trigger information, from the target vehicle; and
a collector (53) configured to collect the one or more retrieval data items acquired at the third acquirer from a plurality of the vehicles.

(Item 2). In the data collection system according to Item 1:
the second acquirer is configured to acquire the processing target data from the target vehicle upon the first determiner determining that the first condition is met.

(Item 3). In the data collection system according to Item 1 or 2:
the processing target data includes:
speech data, image data or biometric data of a driver in the target vehicle; or behavioral data, operation data, or status data of the target vehicle for a complex vehicle state and a complex driving operation to be specified.

(Item 4). In the data collection system according to any one of Items 1 to 3:
the trigger condition includes at least a condition for detecting that a driver in the target vehicle is expressing dissatisfaction.

(Item 5). In the data collection system according to any one of Items 1 to 4:
the information processor is in an external device communicable with the target vehicle.

(Item 6). In the data collection system according to any one of Items 1 to 4:
the first acquirer, the second acquirer, and the first determiner are in the target vehicle;
the distributor and the information processor are in an external device communicable with the target vehicle;
the trigger information distributed to the target vehicle by the distributor of the external device indicates the processing target data required for generating the second determination data;
the target vehicle acquires the processing target data according to the trigger information and transmits the processing target data to the external device; and
the information processor of the external device executes the specific processing by using the processing target data transmitted from the target vehicle.

(Item 7). In the data collection system according to any one of Items 1 to 4:
the information processor is in the target vehicle.

(Item 8). The data collection system according to any one of Items 1 to 7 further comprises:
a parameter storage (55) that stores an adjustment parameter linked to a driver ID; and
an ID acquirer (43) that acquires the driver ID of the driver who is in the target vehicle,
wherein:
the information processor applies the adjustment parameter specific to the driver ID to the specific processing to adjust processing content so as to reduce a variation of the processing result caused by individual differences among drivers.

(Item 9). In the data collection system according to any one of Items 1 to 8:
the specific processing includes: processing to recognize a status of a driver in the target vehicle from image data; processing to recognize words uttered by the driver from audio data; or statistical processing.

(Item 10). The data collection system according to any one of Items 1 to 9 further comprises:
a data collector (41) that collects and accumulates data from the target vehicle in a time-series manner,
wherein:
the first acquirer, the second acquirer, and the third acquirer acquire at least part of: the first determination data, the second determination data, and the processing target data from the data collector.

What is claimed is:

1. A data collection system comprising:
at least one computer including: at least one processor that executes a program; and/or at least one integrated circuit,
the at least one computer implementing:
a distributor configured to distribute, to one or more vehicles, trigger information in which a trigger condition and one or more retrieval data items to be acquired upon establishment of the trigger condition are linked to each other, wherein: the trigger condition indicates a condition that a determination data is to meet; the trigger condition is defined by a first condition and a second condition in combination; the second condition is a condition separate from the first condition; and a result of specific processing on one or more data items acquired from the vehicle is used as the determination data for the second condition;
a trigger storage in a target vehicle configured to store the trigger information, wherein the target vehicle is the vehicle to which the trigger information is distributed;
a first acquirer configured to acquire, from the target vehicle, a first determination data being the determination data that is a data on the target vehicle and is used for the first condition according to the trigger information stored in the trigger storage;
a first determiner configured to determine whether or not the first condition is met, by using the first determination data acquired by the first acquirer;
a second acquirer configured to acquire, from the target vehicle, a processing target data required for generating a second determination data being the determination data that is a data on a driver and is used for the second condition;
an information processor configured to execute the specific processing using the processing target data acquired by the second acquirer;
a second determiner configured to determine whether or not the second condition is met, by using the second determination data which is a processing result of the information processor;
a third acquirer configured to, upon the first determiner determining that the first condition is met and the second determiner determining that the second condition is met, acquire the one or more retrieval data items linked to the trigger condition in the trigger information, from the target vehicle; and
a collector configured to collect the one or more retrieval data items acquired at the third acquirer from a plurality of the vehicles.

2. The data collection system according to claim 1, wherein:
the second acquirer is configured to acquire the processing target data from the target vehicle upon the first determiner determining that the first condition is met.

3. The data collection system according to claim 1, wherein:
the processing target data includes:
speech data, image data or biometric data of a driver in the target vehicle; or behavioral data, operation data, or status data of the target vehicle for a complex vehicle state and a complex driving operation to be specified.

4. The data collection system according to claim 1, wherein:
the trigger condition includes at least a condition for detecting that a driver in the target vehicle is expressing dissatisfaction.

5. The data collection system according to claim 1, wherein:
the information processor is in an external device communicable with the target vehicle.

6. The data collection system according to claim 1, wherein:
the first acquirer, the second acquirer, and the first determiner are in the target vehicle;
the distributor and the information processor are in an external device communicable with the target vehicle;
the trigger information distributed to the target vehicle by the distributor of the external device indicates the processing target data required for generating the second determination data;
the target vehicle acquires the processing target data according to the trigger information and transmits the processing target data to the external device; and
the information processor of the external device executes the specific processing by using the processing target data transmitted from the target vehicle.

7. The data collection system according to claim 1, wherein
the information processor is in the target vehicle.

8. The data collection system according to claim 1, wherein
the at least one computer further implements:
a parameter storage that stores an adjustment parameter linked to a driver ID and
an ID acquirer that acquires the driver ID of the driver who is in the target vehicle,
wherein:
the information processor applies the adjustment parameter specific to the driver ID to the specific processing to adjust processing content so as to reduce a variation of the processing result caused by individual differences among drivers.

9. The data collection system according to claim 1, wherein:
the specific processing includes: processing to recognize a status of a driver in the target vehicle from image data; processing to recognize words uttered by the driver from audio data; or statistical processing.

10. The data collection system according to claim 1, wherein
the at least one computer further implements:
a data collector that collects and accumulates data from the target vehicle in a time-series manner,
wherein:
the first acquirer, the second acquirer, and the third acquirer acquire at least part of: the first determination data, the second determination data, and the processing target data from the data collector.

11. An in-vehicle device comprising:
at least one computer including: at least one processor that executes a program; and/or at least one integrated circuit,
the least one computer implementing:
a trigger storage configured to store trigger information in which a trigger condition and one or more retrieval data items to be acquired upon establishment of the trigger condition are linked to each other, wherein: the trigger condition indicates a condition that a determination data is to meet; the trigger condition is defined by a first condition and a second condition in combination; the second condition is a condition separate from the first condition; and a result of specific processing on one or more data items acquired from a vehicle is used as the determination data for the second condition;
a first acquirer configured to acquire, from the vehicle, a first determination data being the determination data that is a data on the target vehicle and is used for the first condition according to the trigger information stored in the trigger storage;
a first determiner configured to determine whether or not the first condition is met, by using the first determination data acquired by the first acquirer;
a second acquirer configured to acquire, from the vehicle, a processing target data required for generating a second determination data being the determination data that is a data on a driver and is used for the second condition;
a result acquirer configured to transmit the processing target data acquired by the second acquirer to an information processor device inside or outside the vehicle, and to acquire a processing result of the specific processing from the information processor device;
a second determiner configured to determine whether or not the second condition is met, by using the processing result of the specific processing acquired by the result acquirer as the second determination data;
a third acquirer configured to, upon the first determiner determining that the first condition is met and the second determiner determining that the second condition is met, acquire the one or more retrieval data items linked to the trigger condition in the trigger information, from the vehicle; and
a transmitter configured to transmit the one or more retrieval data items acquired by the third acquirer to an external device.

12. A data collection method comprising:
using trigger information in which a trigger condition and one or more retrieval data items to be acquired upon establishment of the trigger condition are linked to each other, wherein: the trigger condition indicates a condition that a determination data is to meet; the trigger condition is defined by a first condition and a second condition in combination; the second condition is a condition separate from the first condition; and a result of specific processing on one or more data items acquired from a vehicle is used as the determination data for the second condition;
acquiring, from the vehicle, a first determination data being the determination data that is a data on a target vehicle and is used for the first condition according to the trigger information;
determining whether or not the first condition is met, by using the first determination data;
acquiring, from the vehicle, a processing target data required for generating a second determination data being the determination data that is a data on a driver and is used for the second condition;
transmitting the processing target data to an information processor device inside or outside the vehicle, and acquiring a processing result of the specific processing from the information processor device;
determining whether or not the second condition is met, by using the processing result of the specific processing as the second determination data;
upon determining that the first condition is met and the second condition is met, acquiring the one or more retrieval data items linked to the trigger condition in the trigger information, from the vehicle; and
transmitting the one or more retrieval data items to an external device.

13. A program stored in a non-transitory storage medium and causing a computer to execute:
using trigger information in which a trigger condition and one or more retrieval data items to be acquired upon establishment of the trigger condition are linked to each other, wherein: the trigger condition indicates a condition that a determination data is to meet; the trigger condition is defined by a first condition and a second condition in combination; the second condition is a condition separate from the first condition; and a result of specific processing on one or more data items acquired from a vehicle is used as the determination data for the second condition,
acquiring, from the vehicle, a first determination data being the determination data that is a data on the target vehicle and is used for the first condition according to the trigger information;
determining whether or not the first condition is met, by using the acquired first determination data;
acquiring, from the vehicle, a processing target data required for generating a second determination data being the determination data that is a data on a driver and is used for the second condition;
transmitting the acquired processing target data to an information processor device inside or outside the vehicle;
acquiring a processing result of the specific processing from the information processor device;
determining whether or not the second condition is met by using the processing result of the acquired specific processing as the second determination data;
upon determining that the first condition is met and determining that the second condition is met, acquiring the one or more retrieval data items linked to the trigger condition in the trigger information, from the vehicle; and
transmitting the acquired one or more retrieval data items to an external device.
